(19) United States
(12) Patent Application Publication
(10) Pub. No.: US 2018/0220104 A1
(43) Pub. Date: Aug. 2, 2018

(54) Apparatus for Protecting a Delivered Parcel

(71) Applicants: David R. Hall, Provo, UT (US); Mark Hall, Springville, UT (US)

(72) Inventors: David R. Hall, Provo, UT (US); Mark Hall, Springville, UT (US)

(21) Appl. No.: 15/419,274

(22) Filed: Jan. 30, 2017

(51) Int. Cl. H04N 7/18; H04N 5/14; H04N 5/225; G06K 9/00; G08B 21/18

(52) U.S. Cl. CPC H04N 7/183; H04N 5/144; G06Q 50/28; G06K 9/00221; G08B 21/18; H04N 5/2256

(57) ABSTRACT

An apparatus for protecting a delivered parcel is described. The apparatus includes a processor, communicatively connected to a network interface connection, a camera, and a non-transitory storage medium. The non-transitory storage medium includes a monitor module, a notice module, a parcel lock module, a detect module, an alert module, and a parcel unlock module. The monitor module monitors the field of vision of the camera for the placement of a parcel. The notice module notifies a control user associated with the apparatus that a parcel has arrived. The parcel lock module indicates that the parcel is being monitored for movement. The detect module detects movement of the parcel. The alert module alerts the control user when a parcel moves. The parcel unlock module indicate that the parcel is allowed to move.

### TECHNICAL FIELD

The disclosure relates generally to the field of parcel delivery. Specifically, the disclosure relates to the delivery of a parcel to a destination.

### BACKGROUND

The Internet and other technological changes have brought about sweeping changes in communications and commerce. While overnight parcel delivery services have become commonplace in recent years (for example, Federal Express, United Parcel Service, and Airborne), these services have great difficulty delivering to individual homes. The occupant of the home is often not there (being at work, for example) and thus a carrier may have to visit the home two or more times to effect delivery. Often, a parcel delivery person will leave a parcel unattended. An unattended parcel may be stolen, causing inconvenience for the occupant and cost for the retailer. A sophisticated thief may place a fraudulent order using a stolen credit card. The thief has the parcel delivered to a house where the resident is often not present and then steals the parcel when it is left unattended.

Some retailers have used is placing a number of containers at a predetermined location, such as a grocery store or post office. The parcel recipient receives a message that the parcel has been delivered to the predetermined location. The parcel recipient then retrieves the parcel from the predetermined location. This solution allows for the parcel to be kept in a secure location at all times. However, this solution also has the parcel recipient travel to the predetermined location to retrieve a parcel, similar to a post office box. This may delay the receipt of the parcel. The travel of the parcel recipient may cause environment problems, such as pollution from a vehicle or traffic congestion. A successful retailer may be challenged by having all containers at the predetermined location being in use, complicating the delivery of parcels.

Security of parcels and parcel theft has become a challenge for both retailers and consumers. Parcel theft harms many members of society and increases the cost of merchandise.

### BRIEF SUMMARY

An apparatus for protecting a parcel delivered to a door includes a processor communicatively connected to a network interface connection, a camera, and a non-transitory storage medium connected to the processor. The non-transitory storage medium includes a monitor module, a notice module, a parcel lock module, a detect module, an alert module, and a parcel unlock module. The monitor module monitors the field of vision of the camera for the placement of a parcel. The notice module notifies a control user associated with the apparatus that a parcel has arrived. The parcel lock module indicates that the parcel is being monitored for movement. The detect module detects movement of the parcel. The alert module alerts the control user when a parcel moves. The parcel unlock module indicates that the parcel is allowed to move.

A method for protecting a delivered parcel is described. The method includes monitoring a field of vision of the camera for the placement of a parcel. The method includes notifying a control user associated with the apparatus that a parcel has arrived. The method includes indicating that the parcel is being monitored for movement. The method includes detecting movement of the parcel. The method includes alerting the control user when a parcel moves. The method includes indicating that the parcel is allowed to move.

### BRIEF DESCRIPTION OF THE DRAWINGS

A more particular description of the invention briefly described above is made below by reference to specific example. Several examples are depicted in drawings included with this application. An example is presented to illustrate, but not restrict, the invention.

FIG. 1 illustrates a diagram of a use for an apparatus for protecting a delivered parcel.

FIG. 2 illustrates a diagram of an apparatus for protecting a parcel.

FIG. 3 illustrates an apparatus for protecting a parcel in communication with a number of other devices.

FIG. 4 illustrates a device for communication with an apparatus for protecting a delivered parcel.

FIG. 5 illustrates a method for protecting a delivered parcel.

FIG. 6 illustrates a method for protecting a delivered parcel.

### DETAILED DESCRIPTION

A detailed description of the claimed invention is provided below by example, with reference to examples in the appended figures. Those of skill in the art will recognize that the components and steps of the invention as described by example in the figures below could be arranged and designed in a wide variety of different configurations without departing from the substance of the claimed invention. Thus, the detailed description of the examples in the figures is merely representative examples of the invention, and is not intended to limit the scope of the invention as claimed.

In some instances, numerical values are used to describe features such as spreading factors, output power, bandwidths, link budgets, data rates, and distances. Though precise numbers are used, one of skill in the art recognizes that small variations in the precisely stated values do not substantially alter the function of the feature being described. In some cases, a variation of up to 50% of the stated value does not alter the function of the feature. Thus, unless otherwise stated, precisely stated values should be read as the stated number, plus or minus a standard variation common and acceptable in the art.

For purposes of this disclosure, the modules refer to a combination of hardware and program instructions to perform a designated function. Each of the modules may include a processor and memory. The program instructions are stored in the memory, and cause the processor to execute the designated function of the modules. Additionally, a smartphone app and a corresponding computer system for the smartphone app may be used to control the access control.

A purpose of the claimed methods and computer program product is to facilitate the protection of a delivered parcel. In one example, the parcel recipient may be a retail consumer having a parcel delivered to the recipients dwelling. In a different example, a business may have a number of parcels delivered. A parcel may be a container that contains additional items or parcels.

The parcel protection system may use wireless networking protocols. The wireless networking protocols may include any protocol used with Internet of Things (“IoT”) including but not limited to Bluetooth, ZigBee, Ethernet, WirelessHART, DigiMesh, ISA100.11a, IEEE 802.15.4, NFC, ANT, Eddystone, EnOcean, Wi-Fi, and WiMAX. The wireless communication protocol allows the parcel delivery apparatus to communicate with a computing device associated with the person receiving the parcel or with a central server that communicates a combination of the parcel recipient, the parcel delivery service, and the parcel provider.

The method for apparatus protecting a delivered parcel may be implemented by an apparatus that maintains a two-way connection between the apparatus and a control server. In one example a parcel protection system communicates with a control server to receive information about a parcel to be delivered, uses that information to confirm the receipt of the correct parcel, and transmits information to the control server information about the parcel delivered and issues a warning if the parcel unexpectedly moves.

With a control server connected to an apparatus that implements a method, a two-way connection may be maintained. The control server and the Wi-Fi router may communicate over a hardwired connection such as Ethernet, coaxial cable, or fiber optic cable. The device data server and the Wi-Fi router may communicate using a wireless protocol, such as 802.1(g), 802.1(n), or another wireless protocol.

For purposes of this disclosure as used in the present specification and in the appended claims the term “parcel” refers to a thing that is rapped, packaged, or prepared for shipment. A parcel may be used to ship goods in a retail transaction or may be used to privately distribute a gift or goods.

As used in the present specification and in the appended, the term door means a particular device, system, or apparatus used to prevent passage past the device, system, or apparatus.

As used in the present specification and in the appended claims, the term “a number” refers to one or more of an item. Zero not being a number, but rather, the absence of a number.

As used in the present specification and in the appended, the term communication refers to the imparting or exchange of information.

As used in the present specification and in the appended, the term camera refers to a device capable of storing an image, or a series of images, in view of the sensor of a device. A camera may create a digital image or series of images. A camera creating a series of images may store or communicate the series of images using a video format.

As described above, a myriad of problems complicate delivery of parcels to a location where the parcel may be left unattended. When the parcel is left unattended, the parcel may be stolen. The stolen parcel may be blamed on the delivery person, or may cause additional cost for a party who shipped the parcel. Additionally, the parcel may be left in place and vandalized, causing damage that could harm a parcel recipient, a parcel delivery agent, or a party who ships the parcel.

A parcel protection system that records the delivery of a parcel and monitors the parcel for movement when the parcel has not been configured to move. A parcel delivery service may provide shipping discounts or rebates to parties that make use of a parcel retrieval apparatus. A retailer may provide also provide discounts to a party that uses a parcel retrieval apparatus, as the retailer may experience lower rates of inventory loss.

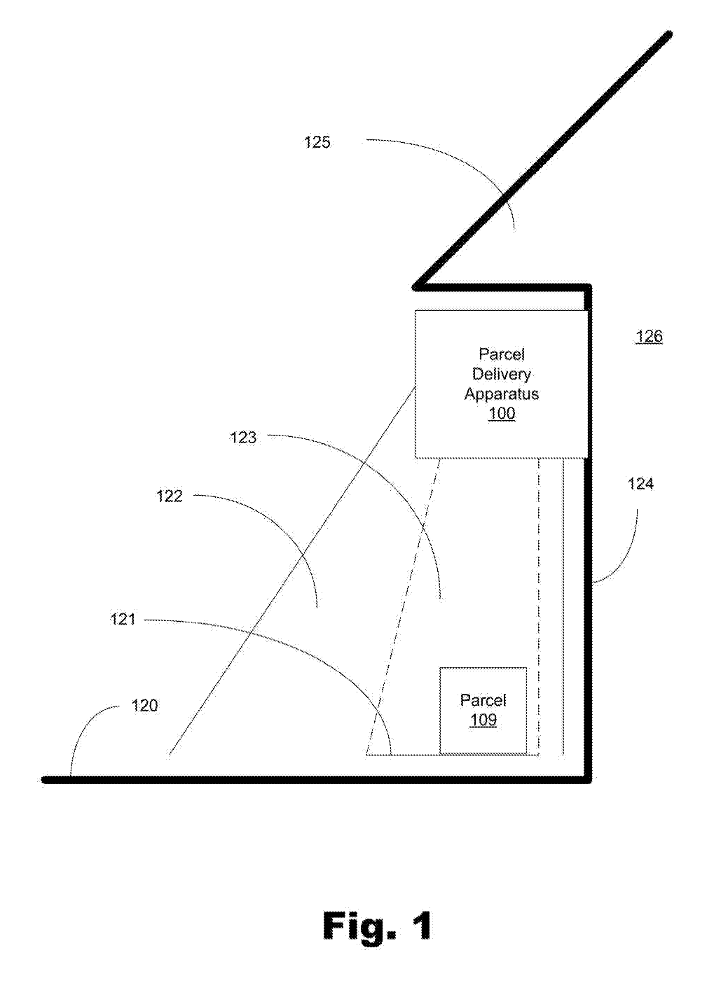

Referring now to the figures, FIG. 1 illustrates a diagram of a use for an apparatus for protecting a delivered parcel. As illustrated, a parcel delivery apparatus (100) is affixed to a building (126) to protect a parcel (109). The parcel (109) is placed in an anticipated parcel placement region (121) on the ground (120) near the building (126). The anticipated parcel placement region (121) is near a door (124) to the building (126). The parcel delivery apparatus (100) has a camera to monitor a parcel. The camera has a field of vision (122). A parcel (109) placed in the anticipated parcel delivery region (121) may be a portion of the field of vision (123).

A number of overall examples will be given according to FIG. 1. In the first example, a parcel service arrives to deliver a parcel (109). The parcel (109) is placed in the anticipated parcel delivery region (121). The parcel delivery apparatus (100) identifies that a parcel (109) has been placed in a portion of field of vision (123).The parcel delivery apparatus (100) sends a notification to an owner that a parcel (109) has arrived and marks that the parcel (109) is not intended on moving. The parcel (109) remains in the anticipated parcel placement region (121). When an authorized individual retrieves the parcel (109), the parcel delivery apparatus performs facial recognition on the individual and allows the parcel (109) to be retrieved without activating a deterrent device.

In the second example, a parcel service arrives to deliver a parcel (109). The parcel (109) is placed in the anticipated parcel delivery region (121). The parcel delivery apparatus (100) identifies that a parcel (109) has been placed in a portion of field of vision (123).The parcel delivery apparatus (100) sends a notification to an owner that a parcel (109) has arrived and marks that the parcel (109) is not intended on moving. A parcel thief takes the package (109) causing it to move from the anticipated parcel placement region (121). The parcel delivery apparatus (100) detects the movement of the parcel and alerts a control user that the parcel has moved. The parcel delivery apparatus (100) then attempts to deter the theft of the parcel by emitting a series of pre-recorded sounds that resemble a shotgun firing. The deterrent startles the parcel thief who drops the package and runs.

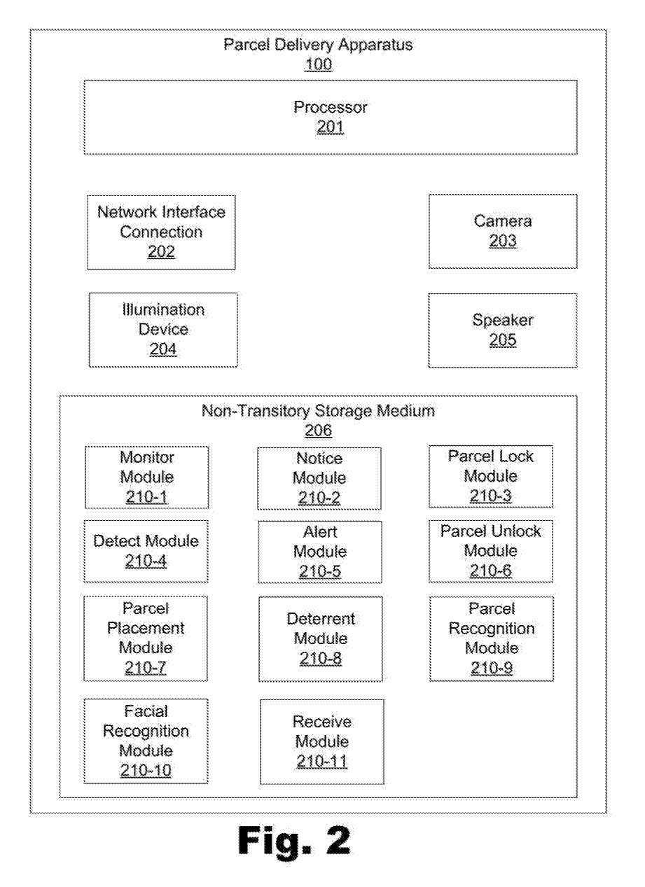

FIG. 2 illustrates a parcel delivery apparatus (100) for protecting a number of parcels that are delivered, according to one example of the principles described herein. The parcel delivery apparatus (100) includes a processor (201) that is communicatively connected to a network interface connection (202), a camera (203), an illumination device (204), a speaker (205) and a non-transitory storage medium (206). The non-transitory storage medium (206) includes a number of modules. Each module includes may include computer program code, hardware, or combination thereof to cause the parcel delivery apparatus to perform a particular task. The processor (201), when executing computer program code, activates other portions of the parcel delivery apparatus (100) to perform an intended task. The processor may be a single unit, or the processor may be a number of processing units associated with portions of the parcel delivery apparatus (100). The non-transitory storage medium (206) includes a monitor module (210-1), a notice module (210-2), a parcel lock module (210-3), a detect lock module (210-4), an alert module (201-5), a parcel unlock module (210-6), a parcel placement module (210-7), a deterrent module (210-8), a parcel recognition module (210-9), a facial recognition module (210-10), and a receive module (210-11).

The network interface connection (202) allows the parcel delivery apparatus (100) to send and receive notifications. The parcel delivery apparatus (100) may receive information pertaining to a parcel (FIG. 1, 109) through the network interface connection (202). The parcel delivery apparatus (100) may send messages relating to the delivery and monitoring of the parcel (FIG. 1, 109) using the network interface connection (202).

The camera (203) monitors the delivery of the parcel (FIG. 1, 109). The camera may take a single image, a series of images, or a video of the events within the field of vision (FIG. 1, 122). The image, images, or video may be analyzed to determine when a parcel (FIG. 1, 109) has been delivered. The image, images, or video may be analyzed to determine when a parcel (FIG. 1, 109) has been moved while it was not unlocked for movement. The camera (203) may be used to take an image, images, or video to identify a parcel thief when the parcel is moved while it is not unlocked for movement.

The illumination device (204) may be used to illuminate the anticipated parcel placement region (FIG. 1, 121). The illumination may occur be projecting a number of lasers, to indicate a shape of the anticipated parcel delivery location (121). The number of lasers may project a line or pattern where the parcel is to be placed. The illumination may occur by projecting a directed light illuminating the anticipated parcel delivery location (121). The illumination device (204) may provide illumination to aid the camera (203) in taking viewable images. The illumination device (204) may include night vision technology, such as infrared, to help the camera (203) take images in the dark. The illumination device (204) may be used as part of an alert alarm to deter package theft. The illumination device (204) may be used to indicate that a parcel has been either locked in place or unlocked and allowed to move.

The speaker (205) may be used by a number of modules. The speaker may be used by a deterrent module (210-8) to emit sounds to deter the theft of the parcel. The speaker (205) may be used to give instructions to the parcel delivery person on delivery of the parcel. The speaker (205) may be used to give instructions to an allowed user to retrieve the parcel. The speaker (205) may be coupled with a microphone to allow the parcel delivery apparatus (100) to provide a user with interaction through the parcel delivery apparatus (100).

The monitor module (210-1) monitors the field of vision (122) of the camera (203) for the placement of a parcel (FIG. 1, 109). The parcel (FIG. 1, 109) may be placed in an anticipated parcel placement region (FIG. 1, 121) in a portion of the field of vision (FIG. 1, 123) of the camera (203). The monitor module (210-1) may use motion detection to detect the arrival of a parcel (FIG. 1, 109). A target area may be provided at the location where a parcel is expected to be delivered. The target are may be located on the surface of a plastic disc, and the target area may have the pattern of the general shape of a box, and a proximity sensor may be provided close enough to the target area, such as on the disc, on the ground below the disc, or on a wall near the target area, so that the range of the proximity sensor is sufficient to detect the surface of the package. The proximity sensor may have a range between one nanometer and ten thousand meters. The proximity sensor may be located near the preferred delivery location of the parcel. The monitor module (210-1) may perform optical recognition of a parcel (FIG. 1, 109) to identify that a delivered parcel (FIG. 1, 109) is an anticipated parcel. The monitor module (210-1) may user a number of other sensors, such as sound, light, or radio frequency to detect the delivery of the parcel (FIG. 1, 109).

The notice module (210-2) notifies a control user associated with the apparatus that a parcel (FIG. 1, 109) has arrived. The notification may use the network interface connection (202) to send a control user a message. The message may be an email, instant message, text message, mutli-media message, or other messages to relay information. The message may include an image, series of images, or video of the parcel (FIG. 1, 109) or delivery of the parcel. The notification may include information about the parcel (FIG. 1, 109) and parcel delivery.

The parcel lock module (210-3), to indicate that the parcel is being monitored for movement. The parcel lock module (210-3) indicates to other modules (210) in the parcel (FIG. 1, 109) is configured to not move. The parcel delivery system (100) may then use the detect module (210-4) to monitor the delivered parcel to ensure that the delivered parcel does not move.

The detect module (210-4), detects movement of the parcel (FIG. 1, 109). The detect module (210-4) may invoke the alert module (210-5) or the deterrent module (210-8). In one example, the detect module (210-4) invokes the deterrent module (210-8) to produce a low-level deterrent, such as an alarm chirp, that indicates the parcel is being monitored without sending an alert. This may prevent false alarm notification from being sent to a control user.

An alert module (201-5), alerts the control user when a parcel moves. The alert may be a message, such as an email, instant message, or text message. The alert may be a number of network packets to an application monitoring the parcel delivery apparatus (100). The alert may be sent to a control server monitored by a control user. The control user may be an individual who is anticipating the parcel.

The parcel unlock module (210-6), indicates that the parcel is allowed to move. The indication may indicate to other modules (210) that the parcel may move and that it should not be monitored or that movement should not be detected. The unlock module (210-6) allows the parcel to be removed without giving an alert, activating a deterrent, or sounding an alarm.

The parcel placement module (210-7) illuminates an anticipated parcel placement region. The parcel placement module (210-7) activates the illumination device (204). The activation of the illumination device (204) illuminates the anticipated parcel placement region (121). The illumination of the anticipated parcel placement region (121) indicates to a parcel delivery person where a parcel is to be placed.

The deterrent module (210-8) deters potential thieves of a package. The deterrent may user an alert output device, such as a speaker (205) or the illumination device (204) to scare away a potential parcel thief. The deterrent module (205) may attempt to create sudden or local attention to deter a potential parcel thief

The parcel recognition module (210-9) recognizes a parcel in view of the camera (203). The parcel recognition module (210-9) may identify a common shape of a parcel, such as a rectangle, and monitor for when that rectangle moves. The parcel recognition module (210-9) may receive information about an anticipated parcel, and may monitor for that parcel to be delivered. The parcel recognition module (210-9) may monitor for the size of the anticipated parcel. The parcel recognition module (210-9) may read labels or tags to identify the parcel.

The facial recognition module (210-10) may recognize the face of an approved parcel retrieval person. The facial recognition module (210-10) may then unlock the parcel, without further input, to allow the parcel to be retrieved. The facial recognition module (210-10) may be used in combination with other authentication methods before releasing the parcel. The facial recognition module (210-10) may recognize the face of the parcel delivery person in order the help identify the parcel.

The receive module (210-11) receives information about the anticipated parcel. The information may include the size of the parcel, the labels on the parcel, the time of delivery, or the face of the person who will deliver the parcel.

An overall example according to FIG. 2 will now be given. The receive module (210-11) receives information related to an anticipated parcel, including that the parcel is expected between 1 PM and 3 PM, the size of the parcel, and the addressee and return address on the parcel. The information also includes a photograph of the parcel delivery person.

At 1 PM, the monitor module (210-1) monitors for the delivery of the parcel. The monitor module (210-1) uses the facial recognition module (210-10) to identify the parcel delivery person. The monitor module (210-1) then invokes the parcel placement module (210-7) to indicate to the parcel delivery person where the anticipated parcel placement region (FIG. 1, 121) is. The parcel delivery person places the parcel in the anticipated parcel placement region (FIG. 1, 121). The monitor module then invokes the parcel recognition module (210-9).

The parcel recognition modules (210-9) then recognizes the parcel based on a combination of the parcel size, the identity of the parcel delivery person, and a number of tags that are affixed to the parcel.

The notice module (210-2) then sends a notification to a control user. The control user is an application that sends notification to the parcel recipient, the parcel service, and the shipper. The recipient may confirm that the package is to be locked.

The parcel lock module (210-3) then locks the parcel into place, meaning that the parcel delivery system (100) will monitor that the parcel does not move and when the parcel does move, will invoke modules in response.

The detect module (210-4) detects movement of the parcel. In this example, a parcel thief comes and attempts to move the parcel. The detect module (210-4) detects the movement and invokes the alert module (210-5) and the deterrent module (210-8).

The alert module (210-5) sends an alert to the parcel recipient and the control user. The alert provides a recording from the camera and real-time access to the camera to observe the movement of the parcel.

The deterrent module (210-8) deters the parcel thief by creating a pulsating activation of the illumination device (204). The deterrent module also uses the speaker (205) to emit a loud recording of a scream. The scream and flashing lights cause the parcel thief to abandon their efforts and flee the area leaving the parcel.

Alerted to the potential theft, the parcel recipient then arrives on scene and examines the parcel. The parcel unlock module (210-6) recognizes the parcel recipient and unlocks the parcel. The parcel is removed and taken into a building.

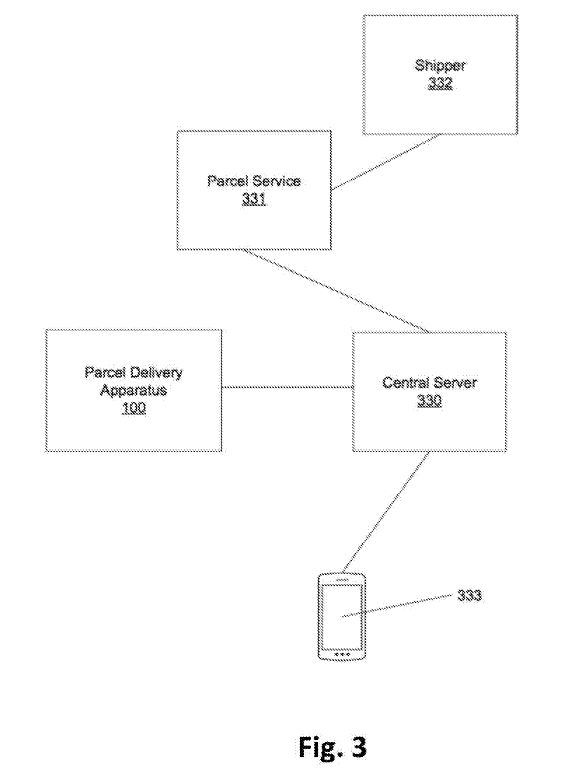

FIG. 3 illustrates an apparatus for protecting a parcel in communication with a number of other devices. This example illustrates the communication of a parcel delivery apparatus (100) with a number of end users. In this example, the alert module (FIG. 2, 210-5) sends an alert using the network interface connection. (FIG. 2, 202). The alert is sent to a central server (330). The central server facilitates security and access to the parcel delivery apparatus (100).

The central server (330) sends a notification to a parcel service and to a device (333) associated with a parcel recipient. The device (333) in this example is a smart phone, but the device may be any mobile phone, tablet, portable computing device, or desk top computer. In other examples the alert may be a voice recording that notifies a non-internet enabled phone with an indication that there has been an issue with the parcel.

The parcel service (331) may notify the shipper (332) that there may have been an issue with the delivery of the parcel.

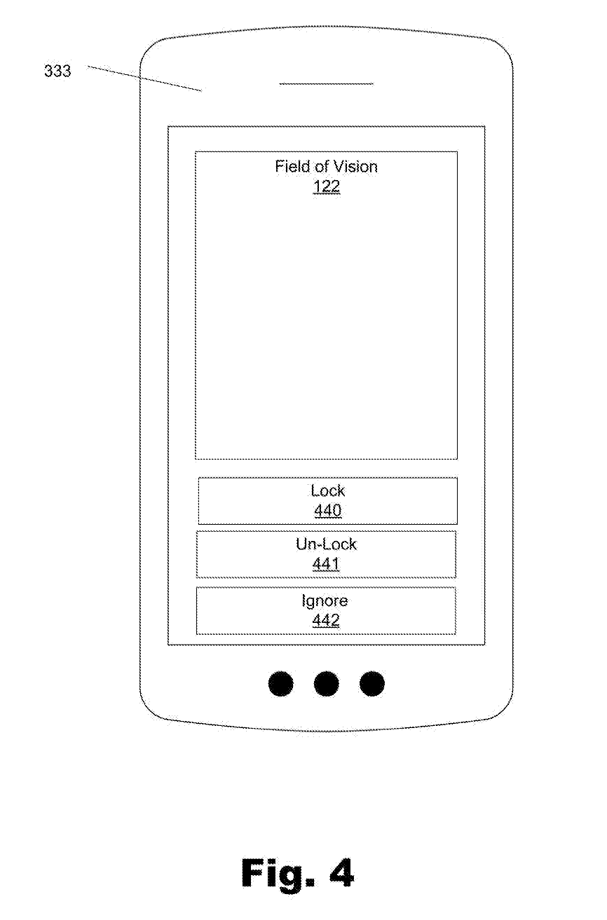

FIG. 4 illustrates a device (333) for communication with an apparatus for protecting a delivered parcel. In this example, the device (333) allows a parcel recipient to view a live video of the field of vision of a parcel being delivered. The user may recognize the parcel, or may determine that said parcel is not actually being delivered. The user may select to lock (440) a parcel (330). The user may recognize that the parcel is being retrieved by an approved third party and the user may elect to unlock (441) a previously delivered parcel. The user may choose to ignore the parcel, causing the parcel delivery apparatus (FIG. 1, 100) to ignore the parcels presence.

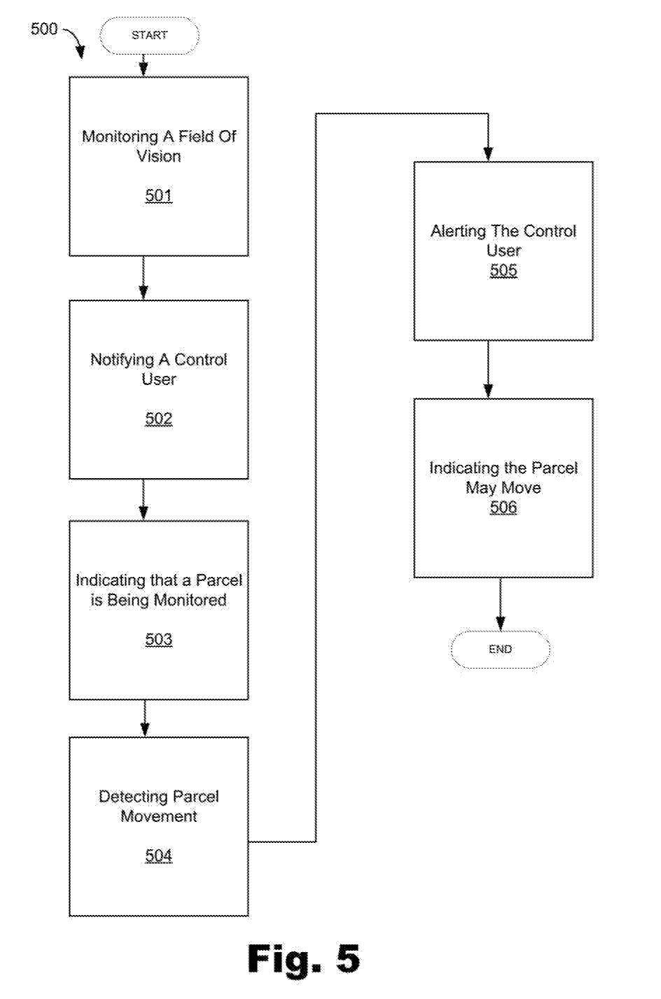

FIG. 5 illustrates a method (500) for protecting a parcel from potential theft using a parcel delivery apparatus (FIG. 1, 100). The method (500) includes monitoring (501) a field of vision of the camera for the placement of a parcel. The method (500) includes notifying (502) a control user associated with the apparatus that a parcel has arrived. The method (500) includes indicating (503) that the parcel is being monitored for movement. The method (500) includes detecting (504) movement of the parcel. The method (500) includes alerting (505) the control user when a parcel moves. The method (500) includes indicating (506) that the parcel is allowed to move.

The method (500) includes monitoring (501) a field of vision of the camera (FIG. 2, 203) for the placement of a parcel (FIG. 1, 109). The monitoring (501) anticipates the delivery of the parcel (FIG. 1, 109). The monitoring may detect he delivery of a parcel.

The method (500) includes notifying (502) a control user associated with the apparatus that a parcel has arrived. The control user may be the parcel recipient. The control user may be a service provider associated with a central server. The control user may simply receive notification of the delivery. The control user, or subsequent users, may invoke a lock function identifying the parcel and configuring the system to issue an alert or deterrent if the parcel unexpectedly moves.

The method (500) includes indicating (503) that the parcel is being monitored for movement. An indication may include a chirp of sound or flash of light indicating that the parcel is secure. The indication may indicate to other modules that the parcel has been secured.

The method (500) includes detecting (504) movement of the parcel. Detecting (504) the movement of the parcel may include motion detection. Detecting (504) the movement of the parcel may include analyzing images or video from the camera (FIG. 2, 203) to identify that the movement detected is occurring with the package.

The method (500) includes alerting (505) the control user when a parcel moves. Alerting (505) the control user may involve sending an electronic message using the network interface connection (FIG. 2, 202). The control user may share the alert with other users.

The method (500) includes indicating (506) that the parcel is allowed to move. The indication may include unlocking the parcel to allow the parcel to be retrieved by a parcel recipient.

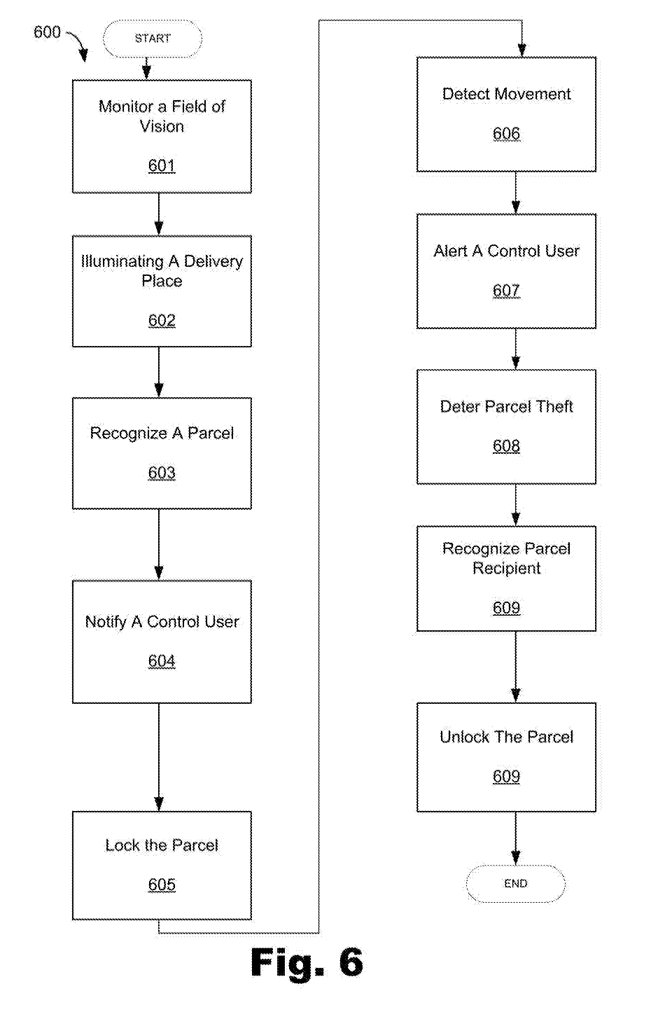

FIG. 6 illustrates a method (500) for protecting a parcel from potential theft using a parcel delivery apparatus (FIG. 1, 100). The method (600) includes monitoring (601) a field of vision of the camera for the placement of a parcel. The method include (600) includes placing (602) a parcel, placing including illuminating an anticipated parcel placement location (FIG. 1, 121). The method (600) includes recognizing (603) the parcel. The method (600) includes notifying (604) a control user of the parcel delivery. The method (600) includes locking (605) the parcel in place. The method (600) includes detecting (606) movement of the parcel while the parcel is locked in place. The method (600) includes alerting (607) a control user of movement of the parcel. The method (600) includes deterring (608) the theft of the parcel using local sounds. The method (600) includes recognizing (609) a parcel recipient retrieving a package. The method (600) include unlocking (610) the parcel.

The method (600) includes monitoring (601) a field of vision of the camera for the placement of a parcel. The method include (600) includes illuminating (602) an anticipated parcel placement location (FIG. 1, 121). The method (600) includes recognizing (603) the parcel. The method (600) includes notifying (604) a control user of the parcel delivery. The method (600) includes locking (605) the parcel in place. The method (600) includes detecting (606) movement of the parcel while the parcel is locked in place. The method (600) includes alerting (607) a control user of movement of the parcel. The method (600) includes deterring (608) the theft of the parcel using local sounds. The method (600) includes recognizing (609) a parcel recipient retrieving a package. The method (600) include unlocking (610) the parcel.

As described above, the method (600) includes monitoring (601) a field of vision of the camera for the placement of a parcel.

The method include (600) includes illuminating (602) an anticipated parcel placement location (FIG. 1, 121). The illumination of the anticipated parcel placement location (FIG. 1, 121) indicates to a parcel delivery person the expected placement of the parcel. The illumination may include a message to the parcel delivery person, such as “place parcel here.” The illumination may be done by activating a light, a number of Light Emitting Diodes (LEDs), or a number of lasers.

The method (600) includes recognizing (603) the parcel. The parcel may be recognized based on an image of the parcel taken with the camera (FIG. 2, 203). The parcel may be recognized based in shape, size, labels, tags, RFID or delivery time. The parcel delivery apparatus (FIG. 1, 100) may receive information about the anticipated parcel.

The method (600) includes notifying (604) a control user of the parcel delivery. The control user is notified using the network interface connection (FIG. 2, 202). The notification informs the control user that the parcel has been delivered.

The method (600) includes locking (605) the parcel in place. Locking the parcel in place causes the parcel delivery apparatus (FIG. 1, 100) to detect movement in the parcel that may indicate that the parcel is being stolen.

As described above, the method (600) includes detecting (606) movement of the parcel while the parcel is locked in place. As described above, the method (600) includes alerting (607) a control user of movement of the parcel.

The method (600) includes deterring (608) the theft of the parcel using local sounds. The theft may be deterred by activating lights or noise generating devices. Similarly, other method of attracting attention may be used, such as lighting fireworks.

The method (600) includes recognizing (609) a parcel recipient retrieving a package. The method may use facial recognition to recognize am intended parcel recipient to allow to retrieve the parcel.

As described above, the method (600) include unlocking (610) the parcel.

The foregoing descriptions of embodiments have been presented only for purposes of illustration and description. They are not intended to be exhaustive or to limit the embodiments to the forms disclosed. Accordingly, many modifications and variations will be apparent to practitioners skilled in the art. Additionally, the above disclosure is not intended to limit the embodiments. The scope of the embodiments is defined by the appended claims.

1. An apparatus for protecting a delivered parcel, the apparatus comprising:
a processor;
a network interface connection, communicatively connected to the processor;
a camera, communicatively connected to the processor; and
a non-transitory storage medium connected to the processor, the non-transitory storage medium comprising:
a monitor module, to monitor a field of vision of the camera for the placement of a parcel;
a notice module, to notify a control user associated with the apparatus that a parcel has arrived;
a parcel lock module, to indicate that the parcel is being monitored for movement;
a detect module, to detect movement of the parcel;
an alert module, to alert the control user when a parcel moves; and
a parcel unlock module, to indicate that the parcel is allowed to move.

2. The apparatus in claim 1, further comprising a parcel placement illumination device, to illuminate where a parcel may be placed

3. The apparatus of claim 2, wherein the non-transitory storage medium further comprises a parcel placement module, to illuminate an anticipated parcel placement region.

4. The apparatus of claim 2, wherein the parcel illumination device and camera provide night vision of an area viewable to the camera.

5. The apparatus of claim 1, further comprising a speaker.

6. The apparatus of claim 5, wherein the non-transitory storage medium further comprises a deterrent module, to deter potential parcel thieves.

7. The apparatus of claim 1, wherein the non-transitory storage medium further comprises a parcel recognition module, to recognize a parcel in view of the camera.

8. The apparatus of claim 1, wherein the parcel recognition module recognizes an anticipated parcel.

9. The apparatus of claim 1, wherein the non-transitory storage medium further comprises a facial recognition module, to recognize the face of an approved parcel retrieval person.

10. The apparatus of claim 1, wherein the non-transitory storage medium further comprises a receive module, to receive identification information of an anticipated parcel.

11. A method for protecting a delivered parcel, the method comprising:
monitoring a field of vision of the camera for the placement of a parcel;
notifying a control user associated with the apparatus that a parcel has arrived;
indicating that the parcel is being monitored for movement detecting movement of the parcel;
alerting the control user when a parcel moves; and
indicating that the parcel is allowed to move.

12. The method of claim 11, further comprising receiving, from a control user, a command to lock a parcel for monitoring; and
locking the parcel for monitoring, the locking parcel for detecting movement.

13. The method of claim 11, further comprising deterring, using an alert output device, the package from being moved.

14. The method of claim 13, wherein detecting movement of the parcel includes deterring the package from being moved.

15. The method of claim 12, further comprising unlocking the parcel, allowing the parcel to be removed without an alarm.

16. The method of claim 15, further comprising recognizing a parcel removal person based on facial recognition.

17. The method of claim 15, further comprising recognizing a parcel removal person based on the identity of a wireless technology device.

18. The method of claim 11, illuminating, using an illumination device, an anticipated parcel delivery zone, indicating to a parcel delivery person a place to deliver the parcel.

19. The method of claim 18, wherein the illumination device comprises a number of lasers.

20. The method of claim 11, monitoring a field of vision of the camera for the placement of a parcel further comprises sensing the proximity of the parcel when the parcel is delivered.
